(19) United States
(12) Patent Application Publication
(10) Pub. No.: US 2005/0161291 A1
(43) Pub. Date: Jul. 28, 2005

(54) Disk brake for a bicycle

(76) Inventor: Jui-Pin Chen, Changhua City (TW)

Correspondence Address: VENABLE LLP, P.O. BOX 34385, WASHINGTON, DC, 20045-9998, US

(21) Appl. No.: 10/765,389

(22) Filed: Jan. 28, 2004

(51) Int. Cl. F16C 1/16

(52) U.S. Cl. 188/2 D

(57) ABSTRACT

A disk brake has a body, a lever and a driving device. The driving device is mounted in the body and has a driving member, a driven member, two brake pads, a ball bearing and two washers. The driving member is connected to and actuated by the lever. The driven member is connected to and actuated by the driving member. The brake pads are mounted in the body, and one of the brake pads is connected to the driven member. The ball bearing with multiple balls is around the driving member. The washers are mounted around the driving member and place the ball bearing between the washers. Each washer has a contact side facing to each other and an annular groove with a concave bottom to receive the balls in cooperation with the groove in the other washer. Accordingly, the contact area between the balls and the washers will be enlarged, and the surfaces of the washers are not easily scraped or damaged.

### BACKGROUND OF THE INVENTION

1. Field of the Invention

The present invention relates to a disk brake, and more particularly to a disk brake for a bicycle and having a low friction to make the operation of the disk brake smooth.

2. Description of Related Art

With reference to FIG. 3, a conventional disk brake for a bicycle in accordance with the prior art comprises a body (50), a lever (52) and a driving device (60). The lever (52) is pivotally attached to the body (50) and is connected to a handle bar through a cable. The driving device (60) is mounted in the body (50) and is connected to and actuated by the lever (52). The driving device (60) comprises a driving member (62), a ball bearing (70), a gasket (72), three steel balls (64), a driven member (63), a biasing member (not numbered), a locking piece (66), a locking nut (not numbered) and two brake pads (68). The driving member (62) is rotatably mounted in the body (50), and the ball bearing (70) is mounted between the drive member (62) and the body (50) to make the driving member (62) rotation at a low friction. The gasket (72) is mounted around the driving member (62) and abuts against the ball bearing (70) to support the balls of the ball bearing (70). The driving member (62) has three guiding recesses (622) to respectively the steel balls (64) in the guiding recesses (622). The driven member (63) is reciprocally mounted in the body (50) and abuts the steel balls (64) to hold the steel balls (64) in place between the driving member (62) and the driven member (63).

The biasing member mounted between the driven member (63) and the locking piece (66) to provide a restitution force to the driven member (63). The locking piece (66) is secured in the body (50) to hold the biasing member in place. The locking piece (66) has a central hole (not number) defined to allow the driven member (63) to extend through the central hole. The locking nut is secured in the body. The brake pads (68) are mounted in the body (50) and face each other. The brake pads (30) are respectively held in place by the driven member (63) and the locking nut.

When the user pulls the handle bar, the lever (52) will be actuated to pivot relative to the body (50) to rotate the driving member (62) with the lever (52). The driven member (63) will be pushed to move relative to the body (50), and the brake pads (68) will be pushed to squeeze a disk mounted on a wheel of a bicycle. Accordingly, a braking effect is provided.

However, because the gasket (72) contacts with each ball of the ball bearing (70) at a single point, the pressure between the gasket (72) and the balls of the ball bearing (70) is huge. The surface of the gasket (72) is easily scraped, and slight scrapes are formed on the surface of the gasket (72). Consequently, the surface roughness of the gasket (72) is increased, such that the friction between the gasket (72) and the ball bearing (70) is also increased to make the operation of the disk device not smooth.

To overcome the shortcomings, the present invention tends to provide a disk brake to mitigate or obviate the aforementioned problems.

### SUMMARY OF THE INVENTION

The main objective of the invention is to provide a disk brake for a bicycle and having a low friction to make the operation of the disk brake smooth. The disk brake has a body, a lever and a driving device. The lever is pivotally mounted on the body. The driving device is mounted in the body and has a driving member, a driven member, two brake pads, a ball bearing and two washers. The driving member is rotatably mounted in the body and is connected to and actuated by the lever. The driven member is reciprocally received in the body and is connected to and actuated by the driving member. The brake pads are mounted in the body, and one of the brake pads is connected to the driven member. The ball bearing with multiple balls is mounted in the body and around the driving member. The washers are mounted around the driving member and place the ball bearing between the washers. Each washer has a contact side facing to each other and an annular groove with a concave bottom defined in the contact side to receive the balls of the ball bearing in cooperation with the groove in the other washer. Accordingly, the contact area between the balls and the washers will be enlarged, and the surfaces of the washers are not easily scraped or damaged.

Other objects, advantages and novel features of the invention will become more apparent from the following detailed description when taken in conjunction with the accompanying drawings.

### BRIEF DESCRIPTION OF THE DRAWINGS

FIG. 1 is an exploded perspective view of a disk brake in accordance with the present invention;

FIG. 2 is an enlarged side plan view in partial cross section of the ball bearing and the washers of the disk brake in FIG. 1;

FIG. 3 is an exploded perspective of a conventional disk brake in accordance with the prior art; and

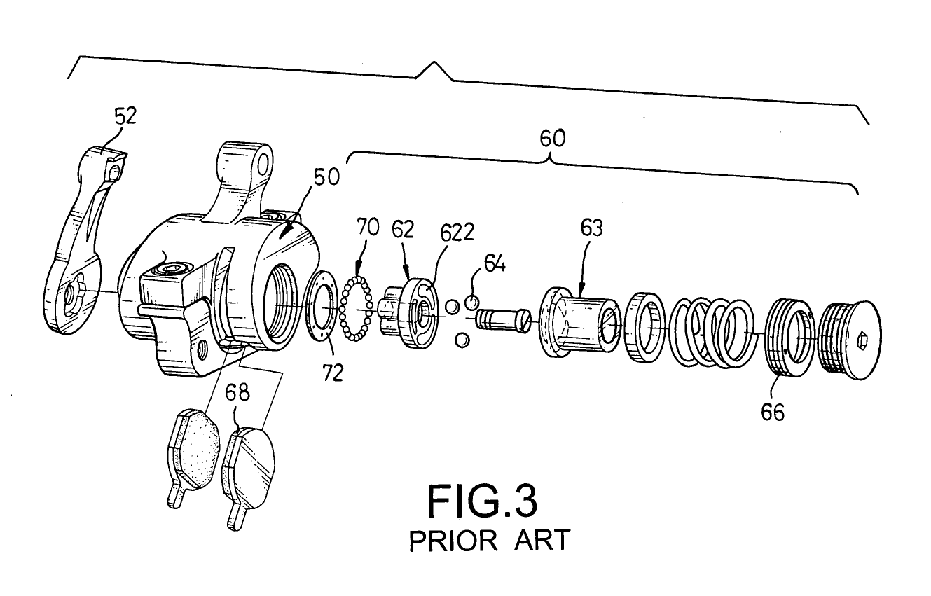

FIG. 4 is an enlarged side plan view in partial cross section of the gasket and a ball of the ball bearing of the conventional disk brake in FIG. 3.

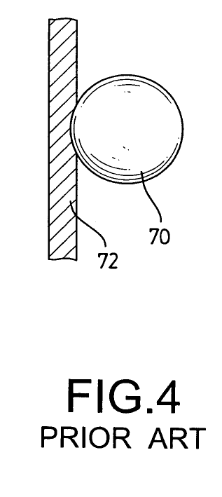

### DETAILED DESCRIPTION OF PREFERRED EMBODIMENT

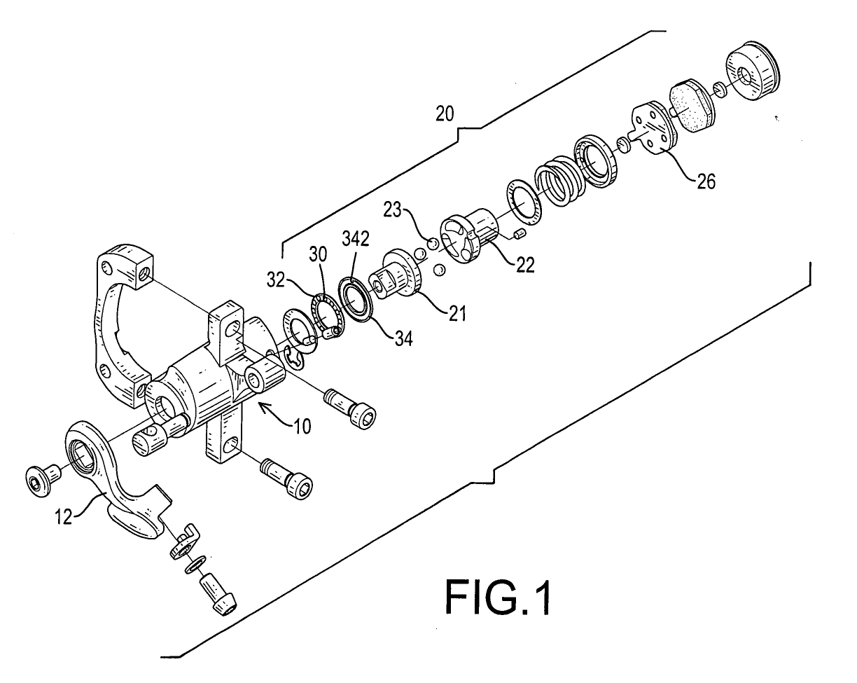

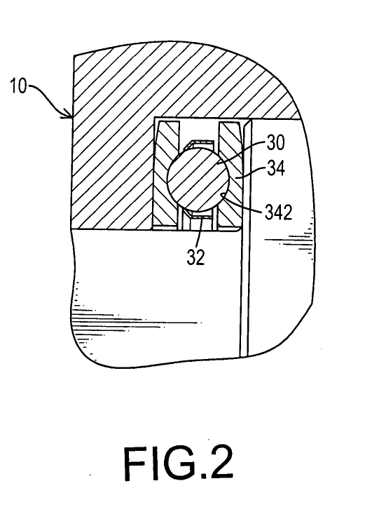

With reference to FIGS. 1 and 2, a disk brake for a bicycle in accordance with the present invention comprises a body (10), a lever (12) and a driving device (20). The body (10) is securely attached to a frame of the bicycle. The lever (12) is pivotally attached to the body (10) and is connected to a handle bar through a cable. The driving device (20) is mounted in the body (10) and is actuated by the lever (12). The driving device (20) comprises a driving member (21), a driven member (22), two brake pads (26), a ball bearing (30) and two washers (34).

The driving member (21) is rotatably mounted in the body (10) and is connected to and actuated by the lever (12). The driven member (22) is reciprocally received in the body (10) and is connected to and actuated by the driving member (21). To connect the driven member (22) to the driving member (21), multiple guiding recesses are respectively defined in the driving member (21) and the driven member (22). Multiple steel ball (23) are respectively mounted in the pairs of facing guiding recess in the driving member (21) and the driven member (22).

The brake pads (26) are mounted in the body (10), and one of the brake pads (26) is connected to the driven member (22) to move with the driven member (22). To connect the brake pad (26) to the driven member (22), a magnet (not shown) is secured in one end of the driven member (22) to attract the brake pad (26) onto the driven member (22). In addition, a biasing member (not numbered) is mounted around the driven member (22) to provide a restitution force to the driven member (22).

The ball bearing (30) with multiple balls is mounted in the body (10) and around the driving member (21). In an optional embodiment, the balls of the bearing (30) are rotatably mounted on an annular ball holder (32). The washers (34) are mounted around the driving member (21) and place the ball bearing (30) between the washers (34). Each washer (34) has a contact side facing to each other and an annular groove (342) with a concave bottom defined in the contact side to receive the balls of the ball bearing (30) in cooperation with the groove (342) in the other washer (34).

With the arrangement of the grooves (342) with concave bottoms in the washers (34), the contact area between the balls and the washers (34) are enlarged. Accordingly, the pressure between the balls and the washers (34) is reduced, so that the surface of the washers (34) will not be scraped or damaged and can be kept at an excellent smoothness. This can make the operation of the disk brake smooth and at a low friction.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. A disk brake for a bicycle comprising:
a body;
a lever pivotally mounted on the body; and
a driving device mounted in the body and comprising a driving member rotatably mounted in the body and connected to and actuated by the lever;
a driven member reciprocally received in the body and connected to and actuated by the driving member;
two brake pads mounted in the body and one of the brake pads connected to the driven member
a ball bearing with multiple balls mounted in the body and around the driving member;
two washers mounted around the driving member and placing the ball bearing between the washers, and each washer having a contact side facing to each other and an annular groove with a concave bottom defined in the contact side to completely contacting with the balls to receive the balls of the ball bearing in cooperation with the groove in the other washer.

2. The disk brake as claimed in claim 1 further comprising an annular ball holder for the balls of the ball bearing being rotatably mounted on the ball holder.
